(19) United States
(12) Patent Application Publication
(10) Pub. No.: US 2011/0092171 A1
(43) Pub. Date: Apr. 21, 2011

(54) SIGNAL COMBINER

(76) Inventor: Greg Delforce, Queensland (AU)

(21) Appl. No.: 12/809,485

(22) PCT Filed: Dec. 19, 2008
(86) PCT No.: PCT/AU2008/001889

§ 371 Date: Dec. 16, 2010

(30) Foreign Application Priority Data
Dec. 20, 2007 (AU) 2007907007

(51) Int. Cl. H04B 1/38

(52) U.S. Cl. 455/90.2

(57) ABSTRACT

At present a number of frequency bands in the region of 450, 950, 900, 1700, 1800, 1900 and 2100 MHz are utilised for cellular and mobile communications, additional bands are under consideration for future expansion of such wireless communication systems. Recently, placing UMTS signals into existing GSM spectrum has received increasing levels of interest. The present invention is directed to systems and methods of combining GSM and UTMS signals in a shared methodology that offers good isolation. A number of different combiner structures are disclosed, the various combiner types each utilise differing transmitter ports topologies to effect the placement of UTMS signals within the existing GSM spectrum and vice versa.

### BACKGROUND OF THE INVENTION

1. Field of the Invention

The present invention relates to an apparatus and method providing diversity in communication networks. In particular although not exclusively the present invention relates to an apparatus and method for combining ports from a GSM communications network with a UTMS network.

2. Discussion of the Background Art

There are a number of cellular mobile phone bands in the region of 450, 950, 900, 1700, 1800, 1900 and 2100 MHz. Others are in consideration for future expansion. Since the explosion in mobile/cellular phone usage during the 1990's, some bands have seen change in the technology used. For example, the 850 bands, at least used in the Americas and Asia have seen a rotation from the AMPS to CDMA technologies. This has occurred due to the constant development of new cellular formats which offer the operator or user increased benefits.

More recently, placing UMTS signals into existing GSM spectrum has received increasing levels of interest. Operators in North America, Europe, Australia and NZ have either installed networks or are undergoing trials to assess the viability of such a network. Popular bands where this has occurred include PCS1900 and 850 (USA) as well as GSM900 (Europe, Australia, NZ). In particular, re-use of the GSM900 spectrum is receiving a large amount of attention.

In designing such a combined network, isolation between the GSM and UTMS systems is important and in particular, the carrier separation between both systems. The recommended carrier to carrier separation for fully coordinated and non-coordinated systems varies according to the recommendation of ECC report 82. For instance, a carrier to carrier separation of 2.6 MHz is recommended (however, some simulations show that a separation as low as 2.2 MHz is possible) for fully coordinated operation. While for non-coordinated operation a minimum carrier to carrier separation of 2.8 MHz is recommended. Thus the carrier to carrier separation can range from 2.2 to 2.8 MHz depending on the RF performance of the base stations and the User Equipment (UE) in the presence of adjacent carriers.

In the case of fully coordinated operation, isolation is not only required between the desired GSM and UTMS carriers but with the carriers of other operators. A non-collated cell of another operator can be a significant source of interference. One possible signal spacing arrangement aimed at reducing potential interference is the so-called sandwich arrangement as shown in FIG. 1. Here the UTMS carriers are deployed in-between the GSM carrier signals.

While it can be seen from the above that it is possible for GSM and UMTS signals to co-exist in a shared methodology, the difficulty in implementing such a shared spectrum arrangements arises more in the deployment of the actual infrastructure. At present there are a number of possible system architectures that provide for the combination of UTMS and GSM systems at a cellular site.

Two possible architectures for the combining UTMS and GSM 900 MHz systems are discussed in Qualcomm ESG, Engineering Services Group, UMTS900 Overview & Deployment Guidelines, November 2006, 80-W1044-1 Rev A. Here the co-location of the UTMS and GSM 900 signal is achieved by either antenna or real-estate sharing arrangements. In the antenna sharing arrangement the same antenna is employed by both the UTMS and GSM base station. In the real-estate sharing arrangement the physical space of the cellular site is shared between the GSM and UTMS antennas.

Examples of both antenna sharing and real-estate sharing are shown in FIG. 2. The first illustrated configuration, configuration 1, is an example of a simple real-estate sharing arrangement where the established GSM base station BTS and its associated infrastructure are utilised to support a new UTMS system (node B). Configuration 2 depicts one arrangement for the implementation of an antenna sharing arrangement, here dual and triple band functionality is obtained from a single antenna housing by coupling mechanically and electrically separate GSM and UTMS feeders.

The third configuration (configuration 3) illustrated in FIG. 2 is a further example of a real-estate sharing arrangement. In this particular instance mechanically and electrically separate antennas are supported by a shared GSM/UTMS feeder system. The fourth illustrated configuration (configuration 4) of FIG. 2, utilises broadband antennas which are able to accommodate a number of cellular services within a given bandwidth. The broadband antennas are coupled to a common feeder network which in this case is a hybrid GSM/UTMS system.

Each of the above discussed configurations have their various advantages and disadvantages. For example configuration 1 offers the highest levels of RF isolation between co-located systems, the down side is the cost of deployment and the amount of real-estate space required. Configurations 2, 3 and 4 all offer systems that are relatively less real-estate intensive, over that of configuration 1, however each of these systems do not offer the same level of RF isolation. In fact configuration 2 may affect existing GSM coverage at the site or limit the optimisation of the UTMS coverage. Likewise configuration 4 limits the flexibility of independently controlling the coverage of the GSM and UTMS system, which can necessitate a complete replanning of the GSM system. The main drawback with a system employing configuration 3 is that it necessitates the need for two diplexers for each sector in the sector (i.e. one close to the antenna and one close to the base station) which results in a loss in output power of the base station. In addition feeder sharing arrangements have an increased risk of intermodulation interference and require higher Voltage Standing Wave Ratio (VSWR) limits.

Clearly it would be advantageous to provide an apparatus, system and method of combining GSM and UTMS signals in a shared methodology that that offers good isolation, that is cost effective and less real-estate intensive than the aforementioned systems of the prior art.

### SUMMARY OF THE INVENTION

### Disclosure of the Invention

Accordingly in one aspect of the present invention there is provided an apparatus for combining communication signals said apparatus comprising:
a first transmission section;
a first receiver section including at first filter module coupled to a first splitter whereby said first splitter provides a first and a second receiver path;
a second transmitter section;
a second receiver section including second filter module coupled to a second splitter whereby said second splitter provides a third and a fourth receiver path; and
wherein the first, second, third and fourth receiver paths each include at least one filter element.

In another aspect of the present invention there is provided an antenna system for a communications network said antenna system comprising:
a first transmission section coupled to a first antenna element;
a first receiver section coupled to said first antenna element, said first receiver section including a first filter module coupled to a first splitter whereby said first splitter provides a first and a second receiver path;
a second transmitter section coupled to a second antenna element;
a second receiver section, coupled to said second antenna element, said second receiver section including second filter module coupled to a second splitter whereby said second splitter provides a third and a fourth receiver path;
said second transmission and said second receiver sections are coupled to a second antenna element; and
wherein the first, second, third and fourth receiver paths each include at least one filter element.

In a further aspect of the present invention there is provided a communications node for a communications network, said communications node comprising:
a first base station;
a first antenna element associated with said first base station;
a first transmission section coupled to the first base station and said first antenna element;
a first receiver section coupled to said first base station and said first antenna element, said first receiver section including a first filter module coupled to a first splitter whereby said first splitter provides a first and a second receiver path;
a second base station;
a second antenna element associated with said second base station;
a second transmitter section coupled to the second base station and said second antenna element;
a second receiver section, coupled to said second antenna element, said second receiver section including second filter module coupled to a second splitter whereby said second splitter provides a third and a fourth receiver path; and
wherein the first, second, third and fourth receiver paths each include at least one filter element.

The apparatus, antenna system or communications node may include at least one additional transmitter section. Preferably the apparatus, antenna system or communications node include a third and a fourth transmission section. Suitably the first, second, third and fourth transmission sections each include at least one filter element. Preferably, the at least one filter element is a bandpass filter.

In the case wherein the antenna system includes a third and fourth transmission sections, the third transmission section is coupled to the first antenna element and the fourth transmission section is coupled to the second transmission element. In the case where the communication node includes a third and fourth transmission sections, the third transmission section is coupled to the first base station and the first antenna element and the fourth transmission section is coupled to the second base station and the second transmission element.

Suitably the first transmission section is coupled to the main transmitter/receiver port of the first base station and the third transmission section is coupled to the diversity transmitter/receiver port of the first base station. Preferably the second transmission section is coupled to the main transmitter/receiver port of the second base station and the fourth transmission section is coupled to the diversity transmitter/receiver port of the second base station. Alternatively the third transmission section may be coupled to main transmitter/receiver port of the second base station and the second transmission section may be coupled to the diversity transmitter/receiver port of the first base station. In yet another embodiment the fourth transmission section may be coupled to the diversity transmitter/receiver port of the first base station, while the third receiver section is coupled to the diversity transmitter/receiver section of the second base station. It will be appreciated by those of skill in the art that further pairings of the transmission sections and main and diversity transmitter/receiver ports are possible.

The receiver sections may include at least one amplifier. Suitably the at least one amplifier is a Low noise amplifier (LNA) unit. Preferably the at least one filter element is a bandpass filter. Additional Low Noise Amplifiers (LNAs) may also be utilised.

In the case of the communication node the first receiver path may be coupled to the main transmitter/receiver port of the first base station, while the second receiver path may be coupled to the diversity transmitter/receiver port of the second base station. The third receiver path may be coupled to the main transmitter/receiver port of the second base station, while the fourth receiver path may be coupled to the diversity transmitter/receiver port of the first base station. Alternatively the fourth receiver path may be coupled to the main transmitter/receiver port of the second base station and the third receiver path may be coupled to the diversity transmitter/receiver port of the second base station. In yet another arrangement of the communications node the third receiver path may be coupled to the diversity transmitter/receiver port of the first base station. It will be appreciated by those of skill in the art that further pairings of receiver paths and main and diversity transmitter/receiver ports are possible.

The first base station may be a GSM base station and the second base station may be a UMTS base station. Alternatively the first and second base stations may be GSM base stations. In yet another embodiment of the present invention the first and second base stations may be UMTS base stations. In one embodiment of the invention the base stations operate in one or more of the following communications frequencies 450-460 MHz, 470-500 MHz, 800-830 MHz, 850-870 MHz, 820-850 MHz, 860-900 MHz, 875-880 MHz, 870-900 MHz, 890-910 MHz, 920-925 MHz, 930-940 MHz, 930-960 MHz, 1850-1910 MHz, 1930-1990 MHz, 1430-1440 MHz, 1710-1755 MHz, 2110-2155 MHz, 2110-2170 MHz , 2500-2690 MHz, such as in the 450, 700, 800, 850, 900, 950, 1700, 1800, 1900, 2100, 2500, 450-460 MHz, 470-500 MHz, 800-960 MHz, 1710-2025 MHz, 2110-2200 MHz and 2500-2690 MHz communications bands.

### BRIEF DETAILS OF THE DRAWINGS

In order that this invention may be more readily understood and put into practical effect, reference will now be made to the accompanying drawings, which illustrate preferred embodiments of the invention, and wherein:

FIG. 1 is a schematic diagram of a suggested frequency arrangement for operators employing at least one UTMS carrier;

FIG. 2 is a schematic diagram depicting various feeder arrangements according to the prior art

FIG. 3 is a schematic diagram depicting one possible configuration of a signal combiner according to one embodiment of the invention.

FIG. 4 is a schematic diagram depicting one possible configuration of a signal combiner according to a further embodiment of the invention

FIG. 5 is a schematic diagram depicting one possible configuration of a signal combiner according to another embodiment of the invention;

FIGS. 6A and 6B are schematic diagram depicting possible transmission spectra for the signal combiners of FIGS. 3 to 5;

FIG. 7 is a schematic diagram depicting one possible configuration of a signal combiner according to one embodiment of the invention.

FIG. 8 is a schematic diagram depicting one possible configuration of a signal combiner according to a further embodiment of the invention

FIG. 9 is a schematic diagram depicting one possible configuration of a signal combiner according to another embodiment of the invention;

FIGS. 10A and 10B are schematic diagram depicting possible transmission spectra for the signal combiners of FIGS. 7 to 9;

FIG. 11 is a schematic diagram depicting one possible configuration of a signal combiner according to one embodiment of the invention.

FIG. 12 is a schematic diagram depicting one possible transmission spectrum for the signal combiners of FIG. 11;

FIG. 13 is a schematic diagram depicting one possible configuration of a signal combiner according to a further embodiment of the invention

FIG. 14 is a schematic diagram depicting one possible transmission spectrum for the signal combiners of FIG. 13;

FIG. 15 is a schematic diagram depicting one possible configuration of a signal combiner according to another embodiment of the invention;

FIG. 16 is a schematic diagram depicting one possible configuration of a signal combiner according to one embodiment of the invention.

FIGS. 17A and 17B are schematic diagram depicting possible transmission spectra for the signal combiners of FIGS. 15 and 16 respectively;

FIG. 18 is a schematic diagram depicting one possible transmission spectra for the signal combiners of FIGS. 13 and 16;

FIG. 19 is a schematic diagram depicting one possible transmission spectra for the signal combiners of FIGS. 13 and 15; and

FIG. 20 is a schematic diagram depicting one possible transmission spectrum for the signal combiners of FIGS. 15 and 16.

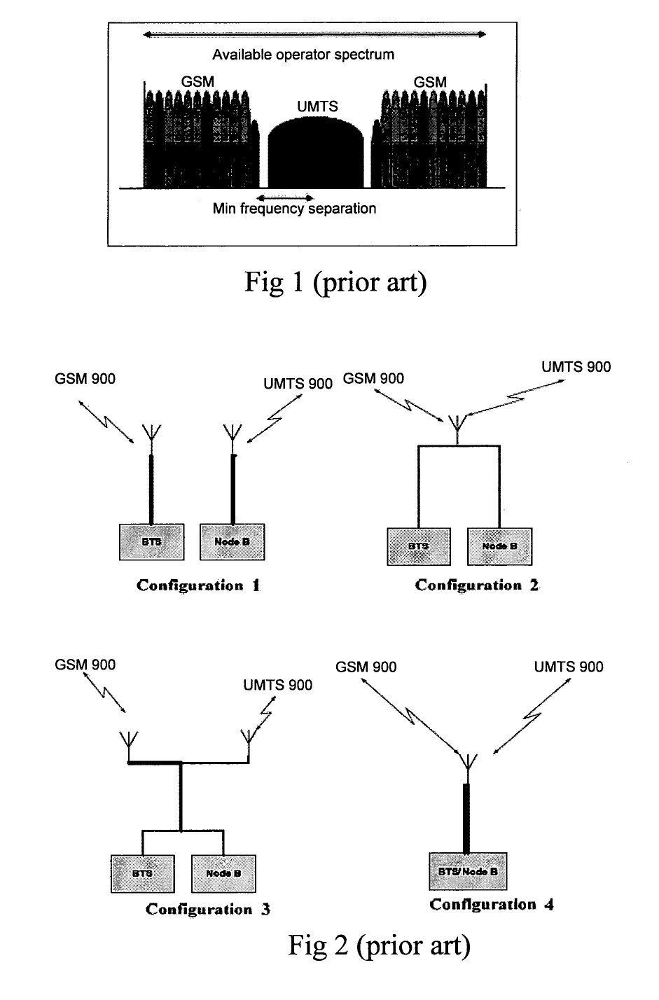

### DESCRIPTION OF EMBODIMENTS OF THE INVENTION

For the purposes of clarity the following description will focus on three main signal combiner types, type 1, type 2 and type 3 combiners. The key difference between the three combiner types is the number of transmitter ports employed.

Type 1 take transmit signals from a maximum of 2 of the 4 ports directed towards the base stations. In the case of combining GSM & UMTS base stations, this means one GSM port & one UMTS port have TX carriers appearing on them. Type 1 combiners are best suited to the situation where there are one or two GSM carriers per sector e.g. a 2:2:2 configuration used in low capacity cells.

Type 2 combiners take transmit signals from a maximum of three of the 4 ports directed towards the base station. In the case of combining GSM & UMTS base stations, this usually means two GSM ports & one UMTS base station ports have TX carriers appearing on them. This type of combiner is best suited where capacity demands three or more GSM carriers per sector and common examples are the 3:3:3 or 4:4:4 configurations. Whilst it is possible to use three or more GSM carriers on a type 1 combiner, a type two combiner in a GSM system means one less level of hybrid combining is necessary. This increases the maximum possible RF transmit output power from the GSM BTS by around 3.5 dB and decreases the likelihood of system degradation through an imbalance between uplink & downlink.

Type 3 combiners take transmit signals from all 4 ports directed towards the base station. In the case of combining GSM & UMTS base stations, this usually means both GSM ports & both UMTS Node-B ports have TX carriers appearing on them. This block diagram is best suited where capacity demands that three or more GSM carriers per sector and two UMTS carriers are necessary. One example is the case where two operators wish to perform RAN (Radio Access Network) sharing of Node Bs.

In addition to the above, the combiner types may be further categorised by a number of additional dimensions such as the mounting position of the combiner, whether the combiner is active or passive, the amount of existing infrastructure utilised by the combiner and the type of combiner filtering utilised.

The mounting position classification simply categorises the combining network on the basis of where it is mounted at a cellular site. There are three possible categories in this class namely: a) near antenna, b) near BTS or c) inside antenna. However in some installations e.g. roof-top, it is important to note that the BTS and antenna are in close proximity, say less than 20 to 30 metres apart, making the three categories less distinctive.

The active and passive classification is based on whether the combiner configuration includes active electronics (hence have overall gain at RF frequencies), or purely passive components (exhibiting an RF receive loss). It will be appreciated by those of skill in the art that it is possible for the active combiner to have its gain adjusted so that the overall gain is 0 dB. For simplicity and ease of description this particular case, the unit will be still characterised as an active type.

The existing equipment classification simply gives an indication as to whether the combiner network has been fitted as an additional external unit to the existing antenna and TMA (tower mounted amplifier) hardware or whether the combiner network has been integrated into the TMA and/or antenna.

The filtering classification seeks to categories combiner network based on the type filtering techniques employed. For example some combiner networks can employ the following RF filter techniques:
i) High Q filters based on ceramic resonators or superconducting technologies;
ii) Medium Q filters using metal combline; or
iii) Combinations of the two above.

The combiner networks discussed below are based on the use of RF filtering techniques. However it will be appreciated by those of ordinary skill in the art that other filtering techniques could be utilised in the implementation of such combiner networks.

The use of type 1 combiners has a number of attractions. Firstly, the transmitter signals from each base station (BTS) can be directed independently to separate antennas or polarizations of the same antenna. This means that parameters such as electrical tilt can be applied separately to each cellular system and each TX can have separate optimization applied. It also means that the TX to TX RF isolation between the two systems will be dominated in most cases by the antenna isolation.

Secondly, they can have RF filters that are cover the full TX & RX frequency allocations for the relevant cellular band, for example 25 MHz for the GSM900 combiner model or 35 MHz for an EGSM equivalent. This has the advantage of giving significant frequency flexibility to the two systems that must share the same frequency band. For example where a guard-band is employed between the cellular systems e.g. GSM & UMTS, it can be selected, adjusted & optimized without the need to re-tune the combiner. If necessary, the two cellular systems can be placed in two or more separate parts of the band as is required by the frequency allocations owned by some operators. Equally the GSM carriers can frequency hop without restriction from the combiner.

Typically with type 1 combiners, BTS transmitter signals are passed through with minimal insertion loss (<1 dB) to separate feeders and onto the antenna. BTS receiver signals in each path are split using a hybrid or Wilkinson combiner to each BTS. An amplifier may be placed before the splitter in the active version.

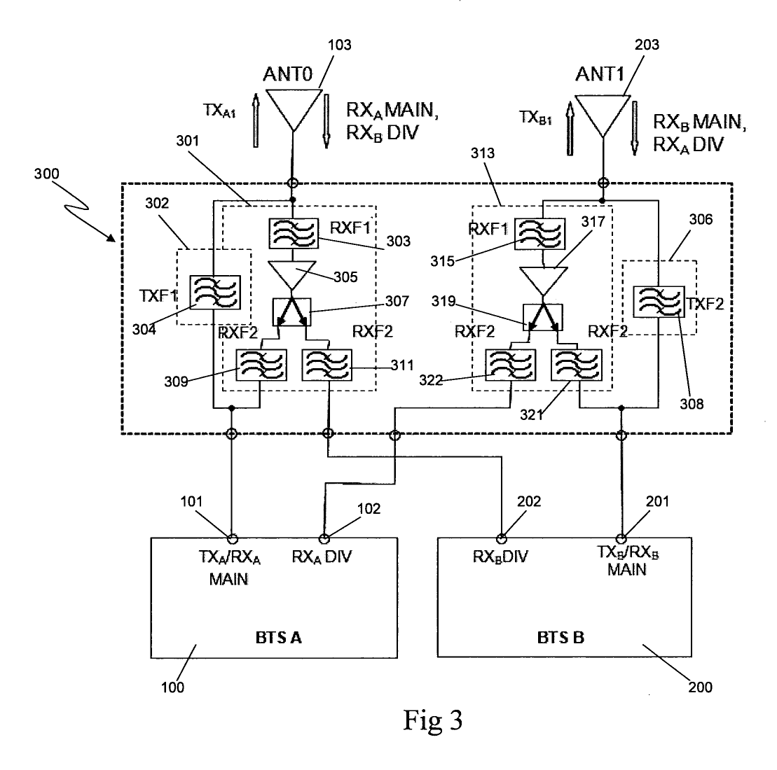

With reference to FIG. 3 there is illustrated one possible configuration of a signal combining network 300 according to one embodiment of the present invention. In this particular example, the type 1 combiner is an active combiner mounted external to antennas 103, 203 . The combining network in this particular instance includes first and second transmitter sections 302, 306 and a first and second receiver section 301, 313.

Each transmitter section 302, 306 includes a bandpass filter 304,308 respectively. The input of the first transmission bandpass filter 304 is coupled to the main transmitter/receiver port 101 of a first base station 100. The output of the filter 304 is then coupled to a first antenna 103. Likewise the second transmission bandpass filter 308 is coupled to the main transmitter/receiver port 201 of a second base station 200. The output of filter 308 is then coupled to a second antenna 203.

The first receiver section includes a first reception bandpass filter 303 the input of which is coupled to the first antenna 103. The output of the filter is then coupled to the input of a first Low Noise Amplifier (LNA) 305. The output of the first LNA is in turn passed to a splitter 307 which provides a first and a second receiver path. The first receiver path is then coupled via a second reception bandpass filter 309 to the main transmitter/receiver port 101 of the first base station 100. The second receiver path is coupled via a third reception bandpass filter 311 to the diversity receiver port 202 of the second base station 200.

The second receiver section 313 in this particular example includes a second reception filter 315 which is coupled between the antenna 203 and a second LNA 317. The output of the second LNA 317 is coupled to a splitter 319, which provides a third and fourth receiver path. The third receiver path in this instance is coupled via a bandpass filter 321 to the main transmitter/receiver port 201 of the second base station 200, while the fourth receiver path is coupled via bandpass filter 323 to the diversity receiver port 102 of the first base station 100.

The advantage of the arrangement of FIG. 3 is that incorrect connection of the combiner 300 will lead to very poor VSWR at transmission frequencies, which will be easily detected by the VSWR monitor used by most field technicians or provided in many modern BTS designs.

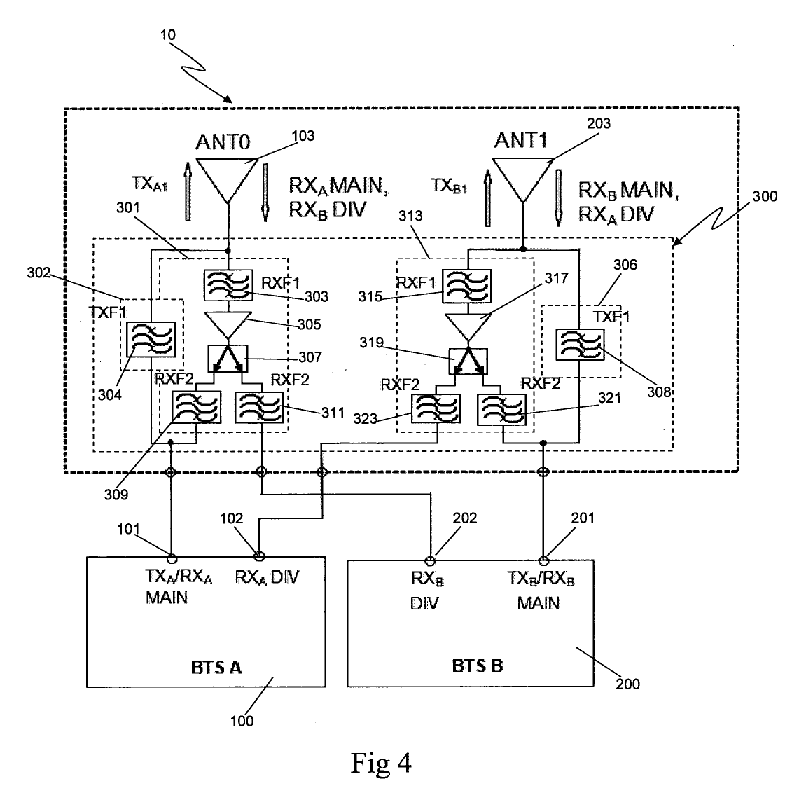

FIG. 4 illustrates the type 1 combiner 300 of FIG. 3, which in this case is embedded in the antenna housing 10. The interconnection between the combiner 300, base stations 100, 200 and antennas 103, 203 is the same as that discussed above. There are a number of advantages to placing the type 1 combiner within the antenna housing 10 as opposed to the external mounting of FIG. 3. Firstly, improved base station receive sensitivity and coverage area can be achieved, as cable insertion loss between base station and antenna is minimized. Mounting the combiner in this manner may also reduce the receive system noise figure by up to 0.5 dB and increase the transmit power by up to 0.5 dB. Secondly, the arrangement saves the cost of two cable tails between the antenna and the combiner. Thirdly, the arrangement gives improved environmental protection to the combiner as it will be protected within the antenna radome.

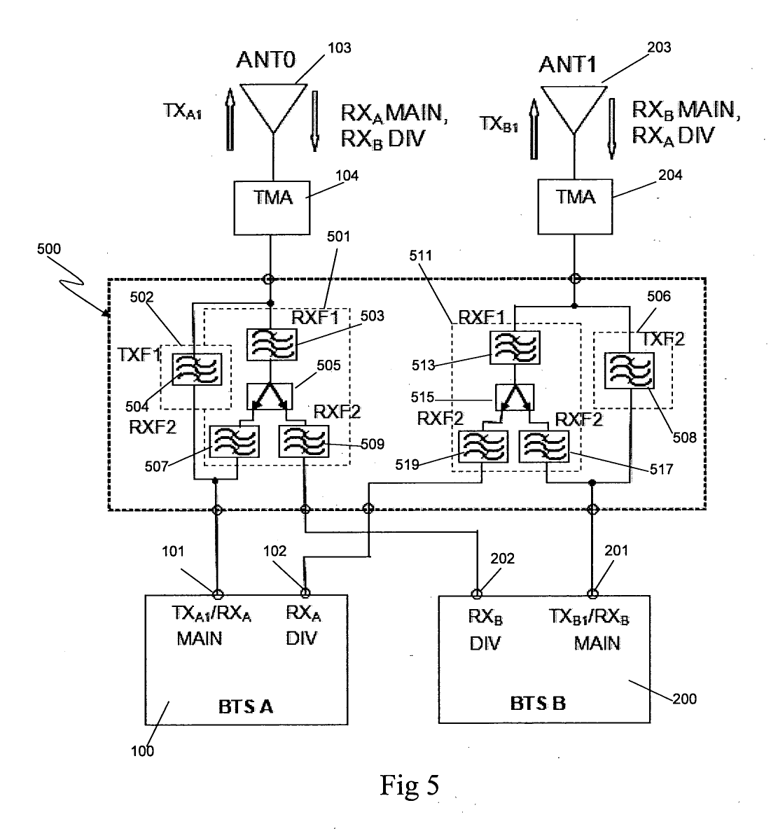

In addition to the above, the applicant has realised that by setting the LNAs 305 & 317 to approximately 4 dB gain, the net receiver gain can be made close to zero. Additional architectures for the combiners of FIGS. 3 and 4 as discussed above are possible. Furthermore active type combiner architectures utilising this arrangement have some system advantages (in conjunction with certain existing base stations & a stand alone TMA), to that of the passive arrangement of FIG. 5 discussed below.

With reference to FIG. 5 there is depicted an example of a passive type 1 combiner according to one embodiment of the present invention. The combiner 500 in this instance includes a first and a second transmission section 502, 506 respectively and a first and a second receiver section 501, 511 respectively.

The first transmission section 502 includes a first transmission bandpass filter 504 coupled between the main transmitter/receiver port 101 of a first base station 100 and the input of a first TMA 104. The TMA 104 is in turn coupled to a first antenna element 103. Likewise the second transmission section 506 includes a second transmission bandpass filter 508 coupled to the main transmitter/receiver port 201 of a second base station 200. The output of the second transmission filter 508 is then coupled to a second antenna 203 via a second TMA 204.

The first receiver section 501 in this instance includes a first bandpass filter 503 the input of which is coupled to the first TMA 104. The output of the first bandpass filter 503 is passed to splitter 505 which divides the received signal into two receiver paths. The first receiver path in this case is coupled via a second bandpass filter 507 to the main transmitter/receiver port 101 of the first base station 100, while the second receiver path is coupled via a third bandpass filter 509 to the diversity receiver port 202 of the second base station 200.

Similarly the second receiver section 511 includes a fourth bandpass filter 513 coupled between the second TMA 204 and splitter 515 which divides the received signal into a third and a fourth receiver path. The third receiver path in this instance is coupled via a fifth bandpass filter 517 to the main transmitter/receiver port 201 of the second base station 200, while the fourth receiver is coupled via a sixth bandpass filter 519 to the diversity receiver port 102 of the first base station 100.

The passive type 1 combiner is useful in applications where TMAs are already in place at a cell site. Active type 1 combiners, as detailed above, are generally more expensive to install in such instances. Normally, there is a relatively long feeder distance between the antenna and the base station. It is expected the cost of a twin TMA plus a type 1 passive combiner plus two long feeder cables, will generally cost less than a type 1 active combiner plus four long feeder cables.

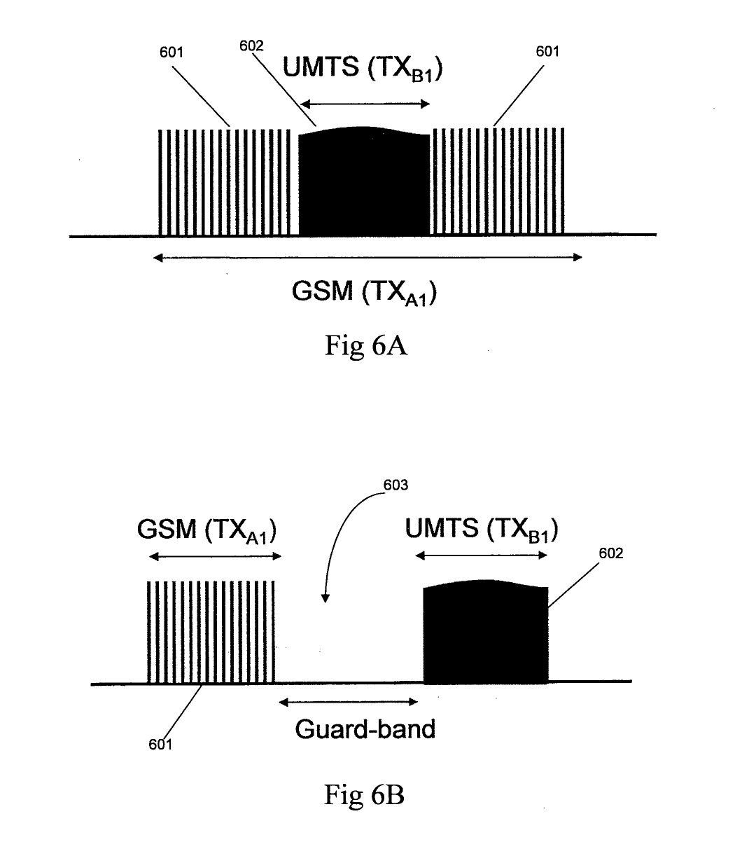

The above discussed type 1 combiners can utilise, in the case of coordinated operation, a sandwich transmission spectrum as shown in 6A. In this case 6A illustrates a sandwich transmission arrangement for GSM 900 and UMTS 900. Here the UMTS 900 transmission frequencies TX_{B1} 602 are sandwiched between the GSM 900 transmission frequencies TX_{A1} 601. The type 1 combiners as above could also utilise a transmission spectrum as illustrated in FIG. 6B. As shown the GSM 900 transmission frequencies TX_{A1} 601 are separated from the UMTS 900 transmission frequencies TX_{B1} 602 by a guard band 603. At 900 MHz transmission the minimum guard band utilised is approximately 4 MHz or less depending on the filter technology used.

As briefly mentioned above, the present invention may also be implemented as a type 2 signal combiner, where the transmitter signals from the two BTS are filter combined and passed to the antenna. Similarly, the BTS receiver signals (both main and diversity) from the antenna are split using a hybrid or Wilkinson combiner circuit to each BTS.

Type 2 combiners are recommended for high capacity cells where transmit signals appear on both antenna ports for at least one of the two base stations e.g. GSM cell sites with 3 or more carriers. Whilst there are several configurations possible for type 2 combiners, there are number of advantages of the arrangement discussed below. Firstly, filter combining (per the arrangements discussed below) of two GSM passbands separated by a minimum of approximately 4.4 MHz (as discussed earlier) makes it possible to avoid the use of high Q ceramic resonators. This reduces the equipment size and cost considerably, particularly at frequencies in the region of 900 MHz and below.

Secondly, type 2 combiners also allow for easy use of the sandwich spectrum arrangement. The use of this arrangement causes less signal distortion of the signals in the middle passband than the two outside ones. This is preferred since the UMTS signal is far more susceptible to distortion e.g. group delay variation, than GSM signals. With some high Q filter combiner solutions this trade-off is not possible.

Thirdly, the configuration allows the arbitrary guard-band between the signals on the first base station and the second base station to be somewhat flexible. Separation can be adjusted according to situation (uncoordinated vs. coordinated), BTS type & interference scenarios which emerge over time. Furthermore by swapping the ports (e.g. UMTS main transmitter/receiver and GSM diversity transmitter/receiver port) as is possible under the type 2 arrangements discussed below, it is possible to change to different spectrum arrangements.

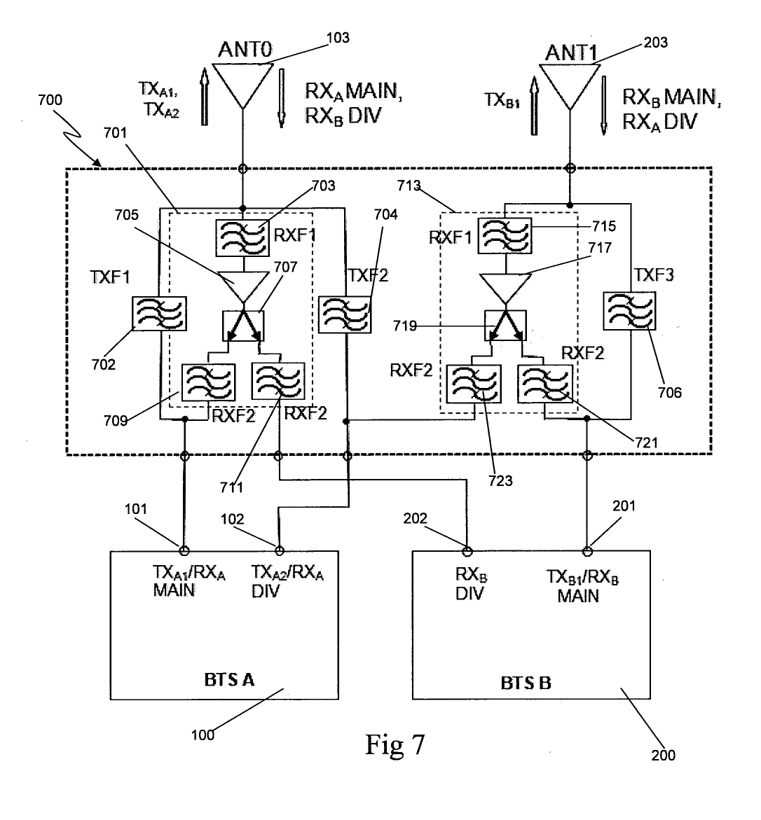

In FIG. 7 there is illustrated one possible configuration of a type 2 combiner according to one embodiment of the present invention. In this particular example the combiner 700 includes three transmission filters 702, 704 and 706. The first transmission filter 702 is coupled between the main transmitter/receiver port 101 of the first base station 100 and antenna 103. The second transmission filter 704 in this case is coupled between antenna 103 and the diversity transmitter/receiver port 102 of the first base station 100, while the third transmission filter 706 is positioned between the main transmitter/receiver port 201 of the second base station 200 and antenna 203.

The combiner 700 as shown also includes first and second receiver sections 701, 713 respectively. The first receiver section includes a first band pass filter 703 the input of which coupled to antenna 103. The output of filter 703 is then passed to a first LNA 705. The output of the first LNA 705 is inturn coupled to the input of splitter 707 which divides the received signal into two receiver paths. The first receiver path is coupled via a second bandpass filter 709 to the main transmitter/receiver port 101 of the first base station 100. The second receiver path provided by splitter 707 is coupled via a third bandpass filter 711 to the diversity receiver port 202 of the second base station.

The second receiver section 713 in this instance includes a fourth bandpass filter 715 coupled between antenna 203 and a second LNA 717 which is in turn coupled to splitter 719. Splitter 719 divides the received signal into a third and fourth receiver path, the third receiver path being coupled via a fifth bandpass filter 721 to the main transmitter/receiver port 201 of the second base station 200. The fourth receiver path is inturn coupled via a sixth bandpass filter 723 to the diversity transmitter/receiver port 102 of the first base station.

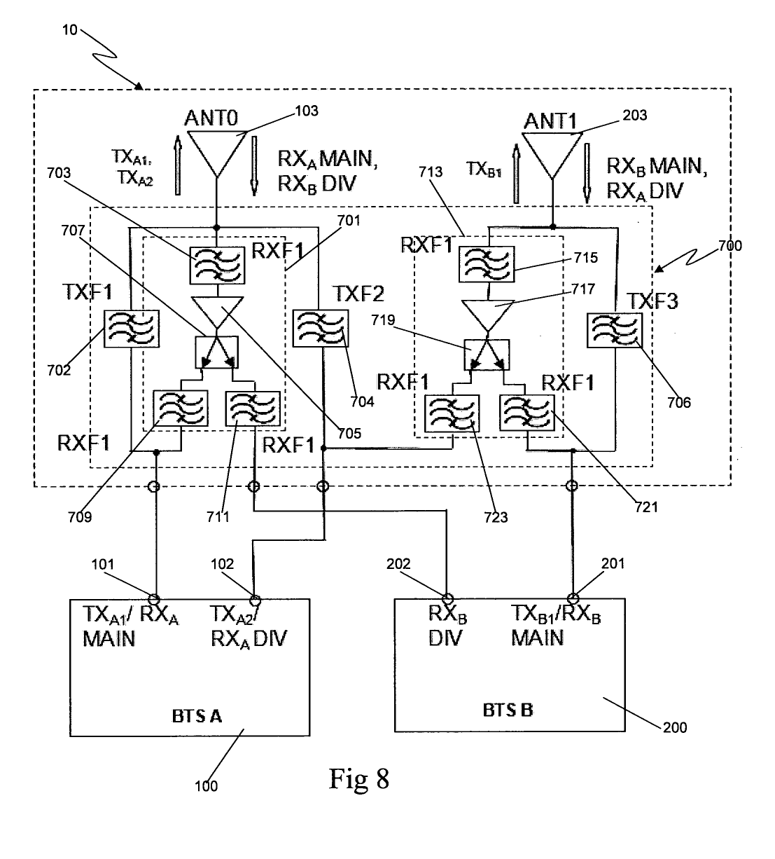

FIG. 8 illustrates the type 2 combiner 700 of FIG. 7, embedded in the antenna housing 10. The interconnection between the combiner 700, base stations 100, 200 and antennas 103, 203 is the same as that discussed in relation to FIG. 7 above. Again mounting the combiner network within the antenna housing gives better base station receive sensitivity and coverage area can be achieved as cable insertion loss between base station and antenna is minimized. In addition the receive system noise figure may be reduced by up to 0.5 dB and the transmit power increased by up to 0.5 dB. In addition the arrangement saves the cost of two cable tails between the antenna and the combiner as well as offering additional environmental protection.

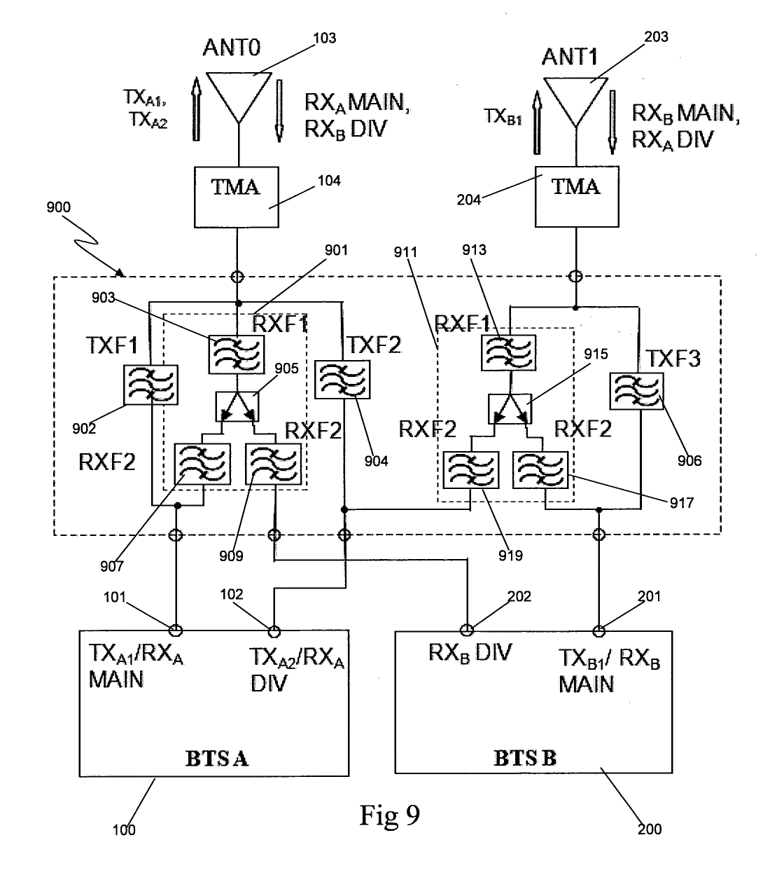

In addition to the above, the applicant has realised that by setting the LNAs 705 & 717 to approximately 4 dB gain, the net receiver gain can be made close to zero. Additional architectures for the combiners of FIGS. 7 and 8 as discussed above are possible. Furthermore active type combiner architectures utilising this arrangement have some system advantages (in conjunction with certain existing base stations & a stand alone TMA) to that of the passive arrangement of FIG. 9 discussed below.

FIG. 9 depicts one possible configuration of a passive type 2 combiner 900 according to one embodiment of the present invention. The combiner 900 in this instance includes three transmission filters 902, 904 and 906. The first transmission filter 902 is coupled between the main transmitter/receiver port 101 of the first base station 100 and antenna 103. The second transmission filter 904 in this case is coupled between antenna 103 and the diversity transmitter/receiver port 102 of the first base station 100, while the third transmission filter 906 is positioned between the main transmitter/receiver port 201 of the second base station 200 and antenna 203.

The first receiver section 901 in this instance includes a first bandpass filter 903 the input of which is coupled to the first TMA 104. The output of the first bandpass filter 903 is passed to splitter 905 which divides the received signal into two receiver paths. The first receiver path is coupled via a second bandpass filter 907 to the main transmitter/receiver port 101 of the first base station 100, while the second receiver path is coupled via a third bandpass filter 909 to the diversity receiver port 202 of the second base station 200.

Similarly the second receiver section 911 includes a fourth bandpass filter 913 coupled between the second TMA 204 and splitter 915 which divides the received signal into a third and a fourth receiver path. The third receiver path in this instance is coupled via a fifth bandpass filter 917 to the main transmitter/receiver port 201 of the second base station 200, while the fourth receiver is coupled via a sixth bandpass filter 919 to the diversity receiver port 102 of the first base station 100.

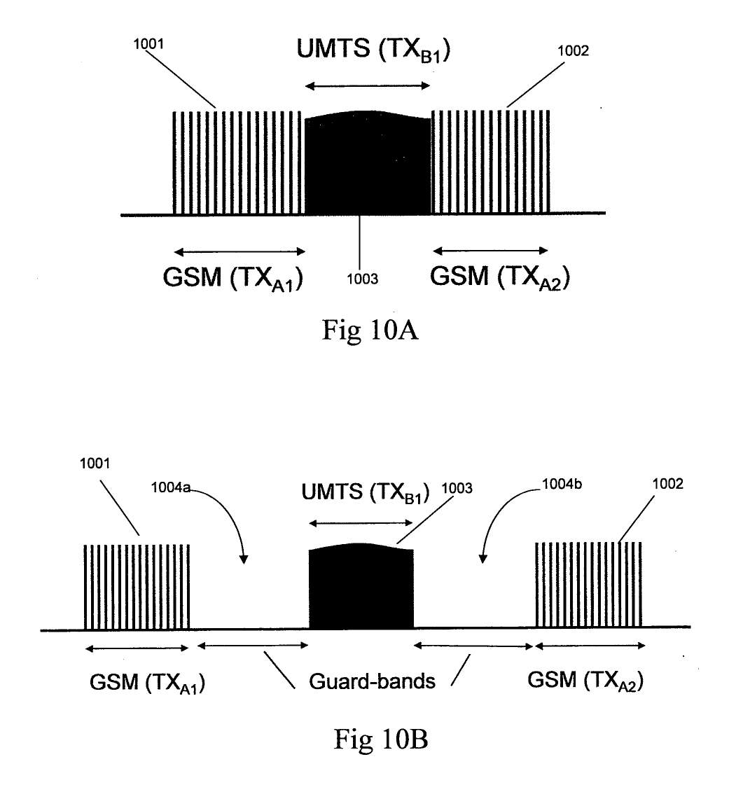

Two possible transmission spectrums for the combiners illustrated in FIGS. 7, 8 and 9 are shown in FIGS. 10A and 10B. FIG. 10A illustrates a first possible transmission spectrum which may be utilised with the type 2 combiners discussed above. In this case the UMTS transmission frequencies TX_{B1} 1003 are sandwiched between the transmission frequencies of the primary GSM transmission frequencies TX_{A1} 1001 and the diversity GSM transmission frequencies TX_{A2} 1002. FIG. 10B shows a second possible transmission spectrum which may be utilised with the type 2 combiners of FIGS. 7 and 8. Here the UMTS transmission frequencies TX_{B1} 1003 are sandwiched between the transmission frequencies of the primary GSM transmission frequencies TX_{A1} 1001 and the diversity GSM transmission frequencies TX_{A2} 1102. However in this case the UMTS transmission frequencies 1003 are separated from the GSM transmission frequencies 1001, 1002 by guard bands 1004a, 1004b.

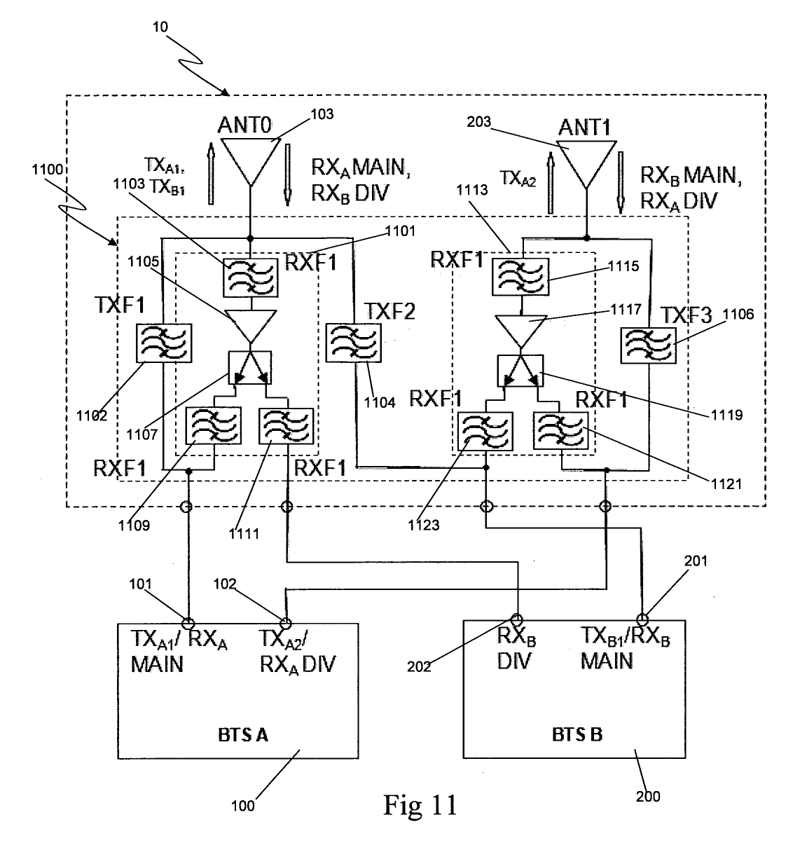

With reference to FIG. 11 there is illustrated yet another possible arrangement of a type 2 combiner 1100 according to one embodiment of the present invention. In this particular example the combiner 1100 is embedded within the antenna housing 10. Again the combiner 1100 includes three transmission filters 1102, 1104 and 1106. The first transmission filter 1102 is coupled between the main transmitter/receiver port 101 of the first base station 100 and antenna 103. The second transmission filter 1104 in this case is coupled between antenna 103 and the main transmitter/receiver port 201 of the second base station 200, while the third transmission filter 1106 is positioned between antenna 203 the diversity transmitter/receiver port 102 of the first base station 100.

The combiner 1100 as shown also includes first and second receiver sections 1101, 1113 respectively. The first receiver section includes a first band pass filter 1103 the input of which coupled to antenna 103. The output of filter 1103 is then passed to a first TMA 1105. The output of the first LNA 1105 is in turn coupled to the input of splitter 1107 which divides the received signal into two receiver paths. The first receiver path is coupled via a second bandpass filter 1109 to the main transmitter/receiver port 101 of the first base station 100. The second receiver path provided by splitter 1107 is coupled via a third bandpass filter 1111 to the diversity receiver port 202 of the second base station 200.

The second receiver section 1113 in this instance includes a fourth band pass filter 1115 coupled between antenna 203 and a second LNA 1117 which is in turn coupled to splitter 1119. Splitter 1119 divides the received signal into a third and fourth receiver path, the third receiver path being coupled via a fifth bandpass filter 1121 to the diversity transmitter/receiver port 102 of the first base station. The fourth receiver path is in turn coupled via a sixth bandpass filter 1123 to the main transmitter/receiver port 201 of the second base station 200.

As will be appreciated by those of skill in the art that the type 2 combiner of FIG. 11 may also be implemented as a stand alone combiner mounted external to the antennas 103, 203, in either an active configuration i.e. integral with the TMA or a passive arrangement external to the TMA.

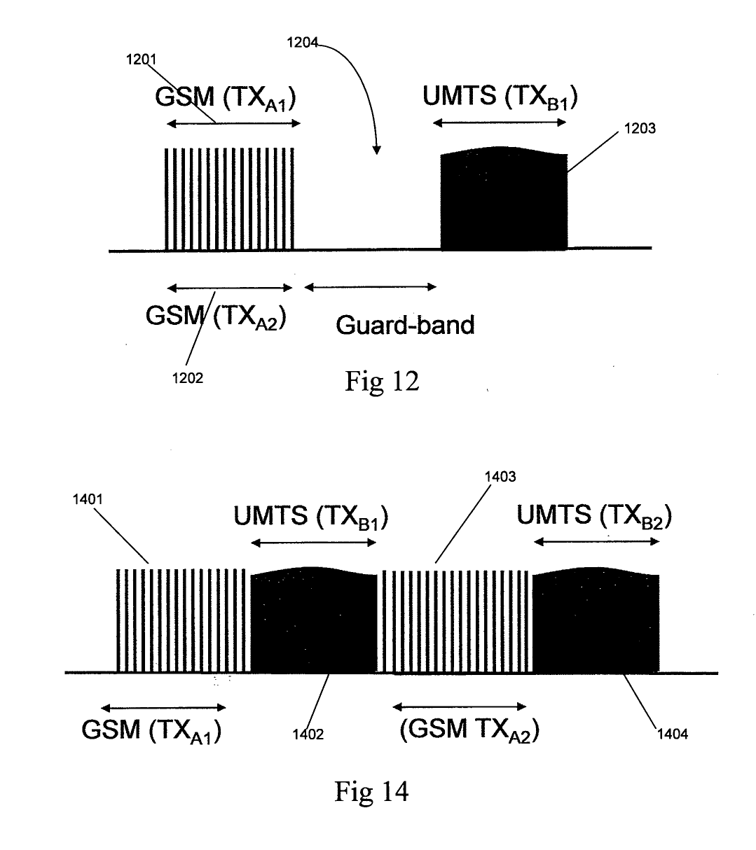

FIG. 12 shows one possible transmission spectrum arrangement which may be utilised the combiner of FIG. 11. As shown the UMTS transmission frequencies TX_{B1} are separated from the primary GSM transmission channel TX_{A1} 1101 and the diversity GSM transmission channel TX_{A2} 1102, which in this case substantially overlap, by guard band 1103. The guard band in the case of GSM and UMTS 900 transmission, and as illustrated here, is around 4 MHz but may be less depending on the type of filter technology used.

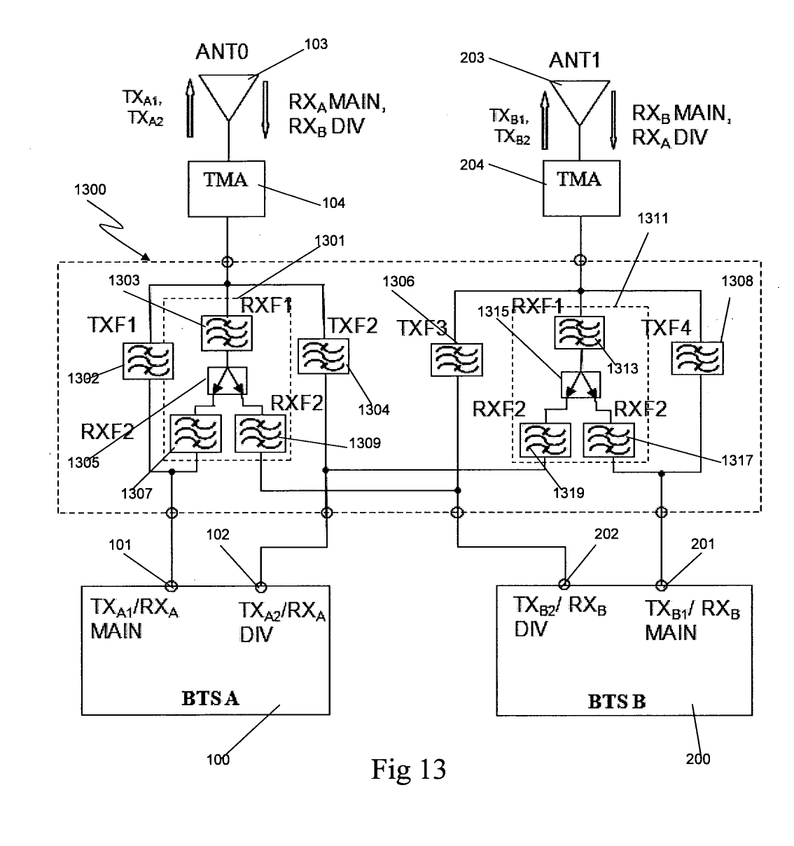

FIGS. 13, 15 and 16 depict various arrangements of type 3 combiners, with type 3 combiners the transmitter signals from the two BTS are filter combined in some specific manner and passed to the antenna. The BTS receiver signals (both main and diversity) are split using a hybrid or Wilkinson combiner circuit to each BTS.

Type 3 combiners share many characteristics with the type 2 combiners discussed above. The major difference, however, is that both RF ports of second base station BTS B become capable of delivering transmit carriers, which increases transmission diversity.

With reference to FIG. 13 there is depicted one possible arrangement of a type 3 combiner 1300 according to one embodiment of the present invention. The combiner 1300 in this instance includes four transmission filters 1302, 1304, 1306 and 1308. The first transmission filter 1302 is coupled between the main transmitter/receiver port 101 of the first base station 100 and the first Tower Mounted Amplifier (TMA) 104, which is in turn coupled to antenna 103. The second transmission filter 1304 in this case is coupled between the first TMA 104 and the diversity transmitter/receiver port 102 of the first base station 100. The third transmission filter 1306 is positioned between the diversity transmitter/receiver port 202 of the second base station 200 and the second Tower Mounted Amplifier (TMA) 204, which is in turn coupled to antenna 203, while the fourth transmission filter 1308 is coupled between the second TMA 204 and the main transmitter/receiver port 201 of the second base station 200.

The combiner 1300, as shown, also includes first and second receiver sections 1301, 1311 respectively. The first receiver section includes a first band pass filter 1303 the input of which coupled to antenna 103 via the first TMA 104. The output of filter 1303 is then passed to the input of splitter 1305 which divides the received signal into two receiver paths. The first receiver path is coupled via a second bandpass filter 1307 to the main transmitter/receiver port 101 of the first base station 100. The second receiver path provided by splitter 1305 is coupled via a third bandpass filter 1309 to the diversity receiver port 202 of the second base station 200.

The second receiver section 1311 in this instance includes a fourth bandpass filter 1313 coupled between antenna 203 via the second TMA 204 and splitter 1315. Splitter 1315 divides the received signal into a third and fourth receiver path, the third receiver path being coupled via a fifth bandpass filter 1317 to the main transmitter/receiver port 201 of the second base station 200. The fourth receiver path is inturn coupled via a sixth bandpass filter 1319 to the diversity transmitter/receiver port 102 of the first base station 100.

In FIG. 14 there is shown one possible transmission spectrum arrangement which may be utilised the combiner of FIG. 13. As can be seen the primary UMTS transmission frequencies TX_{B1} 1402 is sandwiched between the primary GSM transmission frequencies TX_{A1} 1401 and the diversity GSM transmission frequencies TX_{A2} 1403. The diversity GSM transmission frequencies TX_{A2} 1403 in this case is also flanked by the diversity UMTS transmission frequencies TX_{B2} 1404.

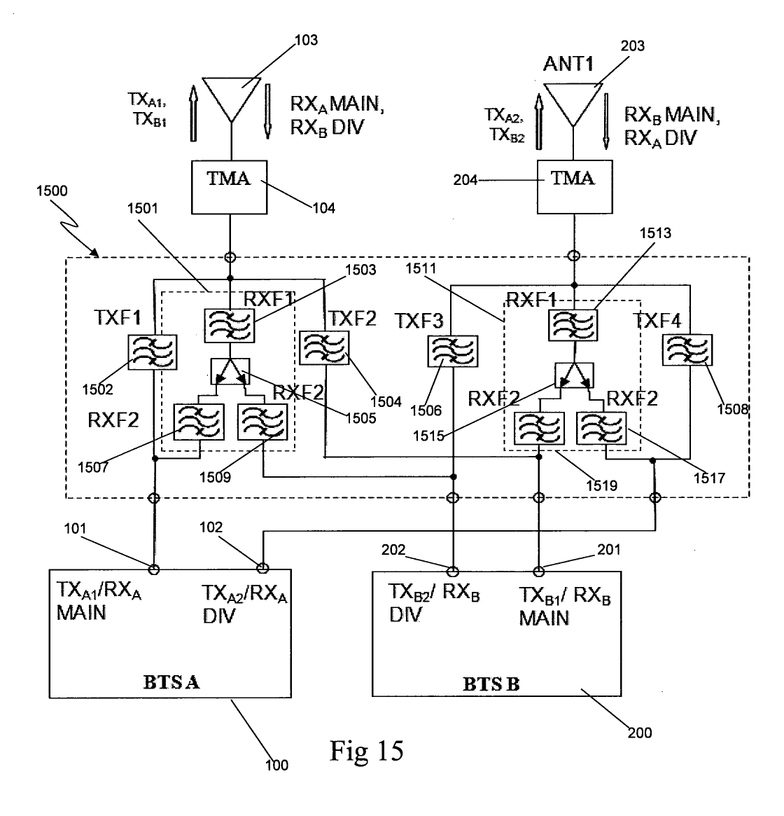

FIG. 15 shows another possible arrangement of a type 3 combiner 1500 according to one embodiment of the present invention. The combiner 1500 in this instance includes four transmission filters 1502, 1504, 1506 and 1508. The first transmission filter 1502 is coupled between the main transmitter/receiver port 101 of the first base station 100 and the first Tower Mounted Amplifier (TMA) 104, which is in turn coupled to antenna 103. The second transmission filter 1504 in this case is coupled between the first TMA 104 and the main transmitter/receiver port 201 of the second base station 200. The third transmission filter 1506 is positioned between the diversity transmitter/receiver port 202 of the second base station 200 and the second Tower Mounted Amplifier (TMA) 204, which is in turn coupled to antenna 203, while the fourth transmission filter 1508 is coupled between the second TMA 204 and the diversity transmitter/receiver port 102 of the first base station 100.

The combiner 1500 as shown also includes first and second receiver sections 1501, 1511 respectively. The first receiver section includes a first bandpass filter 1503 the input of which coupled to antenna 103 via the first TMA 104. The output of filter 1503 is then passed to the input of splitter 1505 which divides the received signal into two receiver paths. The first receiver path is coupled via a second bandpass filter 1507 to the main transmitter/receiver port 101 of the first base station 100. The second receiver path provided by splitter 1505 is coupled via a third bandpass filter 1509 to the diversity receiver port 202 of the second base station 200.

The second receiver section 1511 in this instance includes a fourth bandpass filter 1513 coupled between antenna 203 via TMA 204 and splitter 1515. Splitter 1515 divides the received signal into a third and fourth receiver path, the third receiver path being coupled via a fifth bandpass filter 1517 to the diversity transmitter/receiver port 101 of the first base station 100. The fourth receiver path is inturn coupled via a sixth bandpass filter 1519 to the main transmitter/receiver port 201 of the second base station 200.

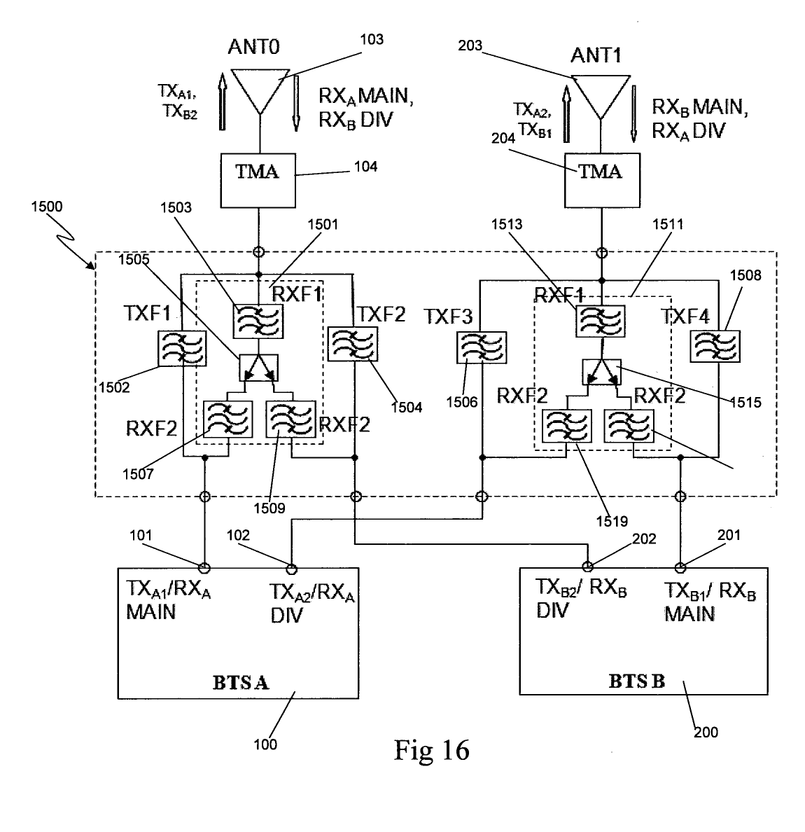

With reference to FIG. 16 there is illustrated an alternate arrangement for the combiner 1500 of FIG. 15. The construction of the combiner 1500 is essentially the same as that discussed above however in this instance the second transmission filter 1504 in this case is coupled between the first TMA 104 and the diversity transmitter/receiver port 202 of the second base station 200. The third transmission filter 1506 in this instance is coupled to the diversity transmitter/receiver port 102 of the first base station 100 while the fourth transmission filter 1508 is couple to the main transmitter/receiver port 201 of the second base station 200.

It will be appreciated by those of skilled in the art the above discussed type 3 combiners may also be implemented as active type combiners. In such configurations the combiners could be integral with the TMA and/or the antenna housing. In the case of a active type 3 combiner arrangements, the applicant has realised that by utilising an LNA with 4 dB gain to each of the receiver sections of the combiners, the net receiver gain can be made close to zero. Furthermore, active type combiner architectures utilising this arrangement have some system advantages (in conjunction with certain existing base stations & a stand alone TMA) to that of the passive arrangement of FIGS. 13, 15 & 16.

One example of use the use of such type 3 combiners is where two UMTS operators wish to RAN share and maintain their own Node B with separate frequency allocations.

As can be seen from the type 2 combiners of FIGS. 7 to 9 and the type 3 combiners of FIGS. 13,15 and 16 a number of transmission filters and receiver filters (e.g. TXF2 & RXF2) are diplexed together. As will be appreciated by those of skill in the art without such diplexing, the required RF signal flow cannot be achieved and thus the relevant base station ports would not be fed the necessary signals to operate correctly.

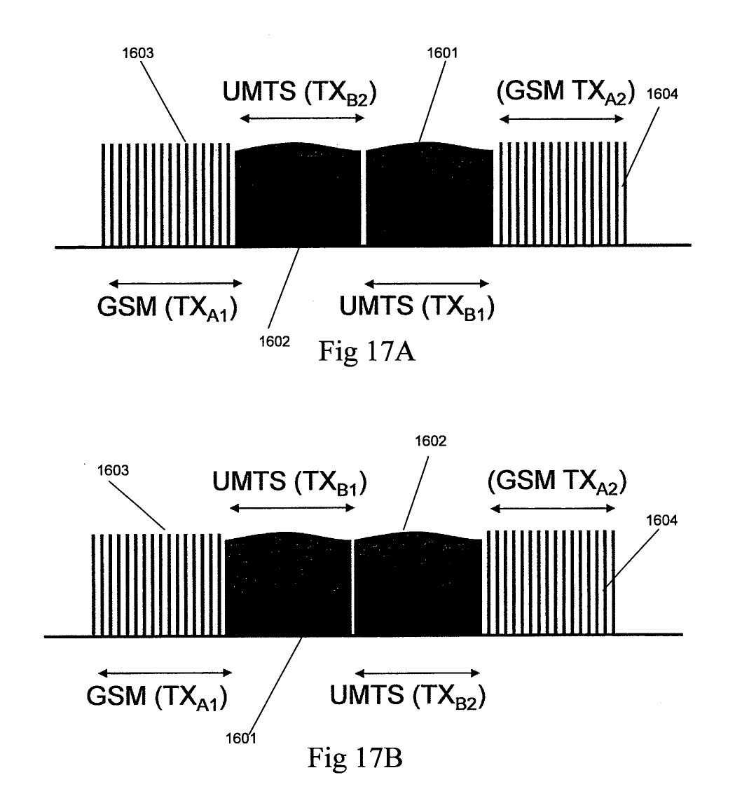

With reference to FIG. 17A there is shown one possible transmission spectrum which may be utilised by the combiner of FIG. 15. Here the primary UMTS transmission band TX_{B1} 1601 and the secondary UMTS transmission band TX_{B2} 1602 are sandwiched between the primary GSM transmission band TX_{A1} 1603 and the secondary GSM transmission band TX_{A2} 1604.

FIG. 17B illustrates one possible transmission spectrum for the combiner 1500 of FIG. 16. Again the primary UMTS transmission band TX_{B1} 1601 and the secondary UMTS transmission band TX_{B2} 1602 are sandwiched between the primary GSM transmission band TX_{A1} 1603 and the secondary GSM transmission band TX_{A2} 1604. However, the spectral position of TX_{B2} 1602 and TX_{B1} 1601 in this case have been transposed.

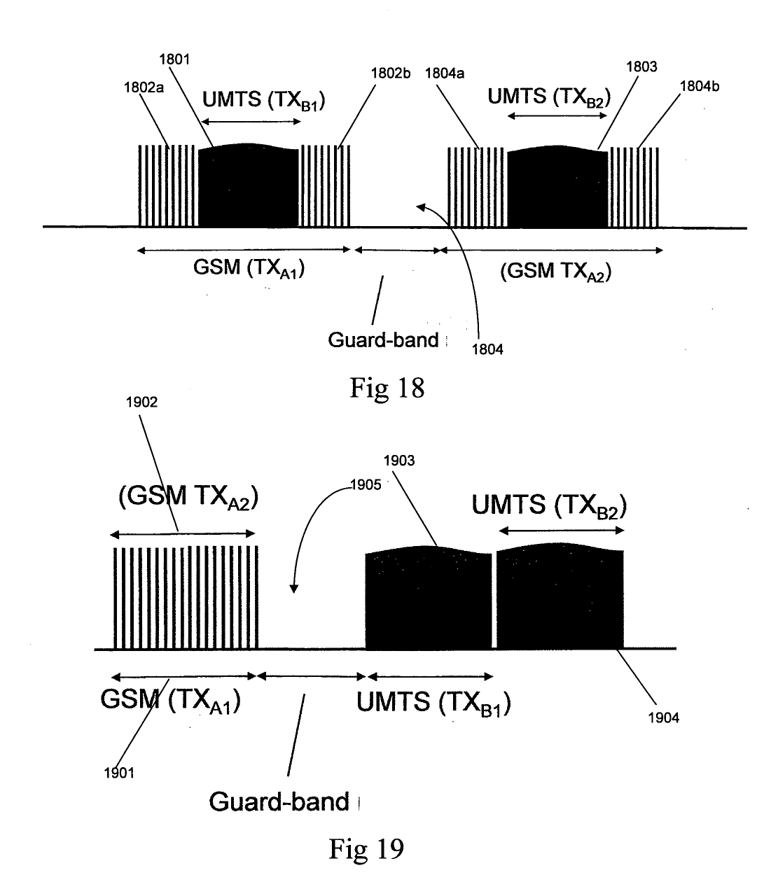

In FIG. 18 there is shown yet another possible transmission spectrum which may be utilised by the combiners of FIG. 13 and FIG. 16. As shown the primary UMTS transmission bands TX_{B1} 1801 are sandwiched between the transmission bands 1802a, 1802b of the primary GSM transmission band TX_{A1}. Likewise the secondary UMTS transmission bands TX_{B2} 1803 are sandwiched between the transmission bands 1804a, 1804b of the primary GSM transmission band TX_{A2}. In the present case the primary and secondary GSM transmission bands TX_{A1}, TX_{A2} are separated by an adequately sized guard band 1805. It will be appreciated by those of ordinary skill in the art that the sizing of the guard band 1805 is dependent on the transmission frequencies utilised and the filter technologies utilised. For example at a transmission frequency of 900 MHz, a guard band of approximately 4 MHz is possible with combline filter technology.

FIG. 19 depicts another possible transmission spectrum which can be utilised by the combiners of FIG. 13 and FIG. 15. Here the primary and secondary GSM transmission bands TX_{A1}, TX_{A2} 1901, 1902 respectively are substantially aligned and are separated by guard band 1905 from the primary and secondary UMTS transmission bands TX_{B1}, TX_{B2} 1903, 1904 respectively.

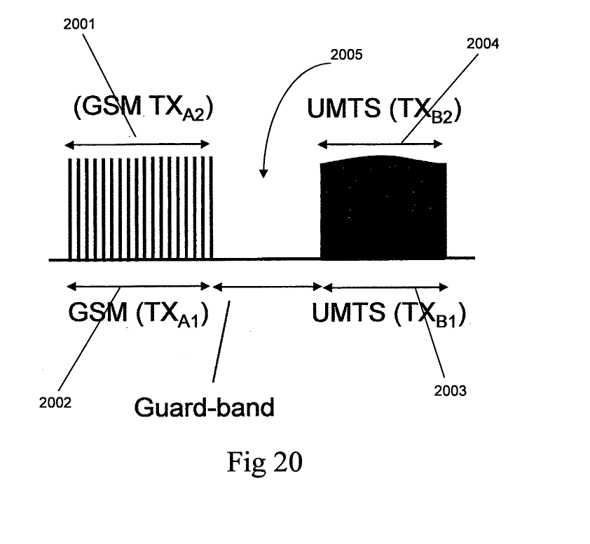

With reference to FIG. 20 there is illustrated a further possible transmission spectrum which may be implemented via the combiners of FIG. 15 and FIG. 16. As shown the primary and secondary GSM transmission bands TX_{A1}, TX_{A2} 2001, 2002 respectively are substantially aligned. Likewise the primary and secondary UMTS transmission bands TX_{B1}, TX_{B2} 2003, 2004 respectively are substantially aligned. Here the primary and secondary GSM transmission bands TX_{A1}, TX_{A2} are separated from the primary and secondary UMTS transmission bands TX_{B1}, TX_{B2} by an adequately sized guard band 2005. Again it will be appreciated by those of ordinary skill in the art that the sizing of the guard band 1805 is dependent on the transmission frequencies and the filter technologies utilised.

It is to be understood that the above embodiments have been provided only by way of exemplification of this invention, and that further modifications and improvements thereto, as would be apparent to persons skilled in the relevant art, are deemed to fall within the broad scope and ambit of the present invention described herein.

1-29. (canceled)

30. An apparatus for combining communication signals said apparatus comprising:
a first transmission section;
a first receiver section including at first filter module coupled to a first splitter whereby said first splitter provides a first and a second receiver path;
a second transmitter section;
a second receiver section including second filter module coupled to a second splitter whereby said second splitter provides a third and a fourth receiver path; and
wherein the first, second, third and fourth receiver paths each include at least one filter element.

31. The apparatus of claim 30 wherein the first and second transmission sections include at least one bandpass filter.

32. The apparatus of claim 30 wherein the first and second filter modules include at least one bandpass filter.

33. The apparatus of claim 30 wherein the at least one filter element is a bandpass filter.

34. The apparatus of claim 30 wherein the first receiver section includes at least one amplifier.

35. The apparatus of claim 34 wherein the at least one amplifier is coupled between the first filter module and the first splitter.

36. The apparatus of claim 30 wherein the second receiver section includes at least one amplifier.

37. The apparatus of claim 36 wherein the at least one amplifier is coupled between the second filter module and the second splitter.

38. The apparatus of claim 30 wherein the apparatus further comprises a third and a fourth transmission section.

39. The apparatus of claim 38 wherein the third and fourth transmission sections include at least one bandpass filter.

40. A communications node for a communications network, said communications node comprising:
a first base station;
a first antenna element associated with said first base station;
a first transmission section coupled to the first base station and said first antenna element;
a first receiver section coupled to said first base station and said first antenna element, said first receiver section including a first filter module coupled to a first splitter whereby said first splitter provides a first and a second receiver path;
a second base station;
a second antenna element associated with said second base station;
a second transmitter section coupled to the second base station and said second antenna element;
a second receiver section, coupled to said second antenna element, said second receiver section including second filter module coupled to a second splitter whereby said second splitter provides a third and a fourth receiver path; and
wherein the first, second, third and fourth receiver paths each include at least one filter element.

41. The node of claim 40 wherein the first and second transmission sections include at least one bandpass filter.

42. The node of claim 40 wherein the first and second filter modules include at least one bandpass filter.

43. The node of claim 40 wherein the at least one filter element is a bandpass filter.

44. The node of claim 40 wherein the first receiver section includes at least one amplifier.

45. The node of claim 44 wherein the at least one amplifier is coupled between the first filter module and the first splitter.

46. The node of claim 40 wherein the second receiver section includes at least one amplifier.

47. The node of claim 46 wherein the at least one amplifier is coupled between the second filter module and the second splitter.

48. The node of claim 40 wherein the node further comprises a third and a fourth transmission section.

49. The node of claim 48 wherein the third and fourth transmission sections include at least one bandpass filter.

50. The node of claim 49 wherein the first transmission section is coupled to the first base station's main transmitter/receiver port, the third transmission section is coupled to the first base station's diversity transmitter/receiver port, the second transmission section is coupled to the second base station's main transmitter/receiver port and the fourth transmission section is coupled to the second base station's diversity transmitter/receiver port.

51. The node of claim 49 wherein the first transmission section is coupled to the first base station's main transmitter/receiver port, the third transmission section is coupled to the second base station's main transmitter/receiver port, the second transmission section is coupled to the first base station's diversity transmitter/receiver port and the fourth transmitter section is coupled to the second base station's diversity transmitter/receiver port.

52. The node of claim 49 wherein the first transmission section is coupled to the first base station's main transmitter/receiver port, the third transmission section is coupled to the second base station's diversity transmitter/receiver port, the second transmission section is coupled to the second base station's main transmitter/receiver port and the fourth transmission section is coupled to the first base station's diversity transmitter/receiver port.

53. The node of claim 49 wherein the first receiver path is coupled to the first base station's main transmitter/receiver port, the second receiver path is coupled to the second base station's diversity transmitter/receiver port, the third receiver path is coupled to the second base station's main transmitter/receiver port and the fourth receiver path is coupled to the first base station's diversity transmitter/receiver port.

54. The node of claim 49 wherein the first receiver path is coupled to the first base station's main transmitter/receiver port, the second receiver path is coupled to the second base station's diversity transmitter/receiver port, the third receiver path is coupled to the first base station's diversity transmitter/receiver port and the fourth receiver path may be coupled to the second base station's main transmitter/receiver port.

55. The node of claim 40 wherein the first base station is a GSM base station and the second base station is a UMTS base station.

56. The node of claim 40 the first and second base stations may be GSM base stations.

57. The node of claim 40 the first and second base stations may be UMTS base stations.

58. An antenna system for a communications network said antenna system comprising:
a first transmission section coupled to a first antenna element;
a first receiver section coupled to said first antenna element, said first receiver section including a first filter module coupled to a first splitter whereby said first splitter provides a first and a second receiver path;
a second transmitter section coupled to a second antenna element;
a second receiver section, coupled to said second antenna element, said second receiver section including second filter module coupled to a second splitter whereby said second splitter provides a third and a fourth receiver path;
said second transmission and said second receiver sections are coupled to a second antenna element; and
wherein the first, second, third and fourth receiver paths each include at least one filter element.
